(19) United States
(12) Patent Application Publication
(10) Pub. No.: US 2011/0196849 A1
(43) Pub. Date: Aug. 11, 2011

(54) METHOD AND APPARATUS FOR COMPRESSING AND DECOMPRESSING DATA RECORDS

(75) Inventor: Paul J. Hays, Lafayette, CO (US)

(73) Assignee: Micro Motion, Inc., Boulder, CO (US)

(21) Appl. No.: 13/123,009

(22) PCT Filed: Oct. 27, 2008
(86) PCT No.: PCT/US2008/081363

§ 371 Date: Apr. 7, 2011

(51) Int. Cl. G06F 17/30

(52) U.S. Cl. 707/693; 707/E17.005

(57) ABSTRACT

A data compression method is provided according to an embodiment of the invention. The data compression method comprises receiving a first data record and at least a second data record. The first data record is compared to the second data record. The second data record is compressed as a difference between the first data record and the second data record.

### TECHNICAL FIELD

The present invention relates to data storage systems, and more particularly, to a method for compressing and decompressing data records in a data storage system.

### BACKGROUND OF THE INVENTION

Digital processing systems frequently store incoming data in an internal or an external memory. The data may be in the form of a digital bit stream, for example. The expense of data storage increases with the increasing demand for more precise data measurements. Therefore, any technique that can reduce the data storage requirements without undermining the ability to retrieve the data at a later date can substantially decrease the associated costs of the processing system.

One method of reducing the data storage requirements is to compress the data prior to storage. There are two widely accepted methods of compressing data, namely lossy and lossless compression. Lossy compression is a method of compressing data where the compression and decompression of the data may lose some information while being compressed or decompressed, but is generally close enough to the original record to be useful. This method is most often used in the compression of multimedia files, such as audio, video, and still images because the human eye or ear generally cannot recognize the difference between the original data and the decompressed data. In contrast, lossless data compression allows the exact original data to be reconstructed from the compressed file. Typical examples of where lossless compression may be used are source code and executable programs. Other examples exist where it may be unclear what information is significant and therefore it is not recommended to discard any of the information in the original file.

One of the tradeoffs typically present in compression is the extreme CPU time required to compress and then decompress the data. Therefore, in any compression routine, the amount of compression must be offset by the CPU time required to perform such a compression.

Prior art methods for compressing continuous or semi-continuous data streams exist where two consecutive records are compared to one another. Typically, the portions of the records that are identical are compressed while the portions of the record not identical are stored in an uncompressed format. This method is useful in many applications where a large percentage of the record contains repeating data. However, this approach suffers in that a great percentage of the data remains uncompressed and thus, requires an unnecessary amount of storage space. The percentage of uncompressed data increases dramatically in situations where consecutive records are continuously changing, for example if an incoming measurement oscillates around a given point. In this example, the overall measurement may not differ significantly among a group of records; however, with consecutive records continuously changing, the amount of required memory is not significantly decreased.

Certain types of data may contain information where consecutive records only vary by a small amount. For example, incoming data received from a transmitter of a flow meter may only vary by a relatively small amount from one measurement to the next. Therefore, the present invention provides a method for compressing and decompressing data where substantially the entire record can be compressed and stored as a difference between the compressed record and a second record.

### ASPECTS

According to an aspect of the invention, a data storage method comprises the steps of:

receiving a first data record and at least a second data record;

comparing the first data record to the second data record; and

compressing the second data record as a difference between the first data record and the second data record.

Preferably, the data storage method further comprises the step of truncating a least significant digit of the second data record prior to the step of compressing.

Preferably, the data storage method further comprises the step of moving a positive or negative indicating digit from a beginning of the first or the at least second data record to an end of the data record.

Preferably, the step of compressing the second data record comprises the step of:

compressing the second data record with a header nibble and one or more data nibbles.

Preferably, the header nibble represents the number of data nibbles that follow.

Preferably, the header nibble represents whether the second data record is greater than, less than, or equal to the first data record.

Preferably, the one or more data nibbles comprise the difference between the first data record and the second data record.

Preferably, the data storage method further comprises the step of:

storing the second data record uncompressed if the difference between the first data record and the second data record cannot be represented by a predetermined number of nibbles.

Preferably, the data storage method further comprises the steps of:

setting the first data record as a baseline record; and\

comparing subsequently received data records to the baseline record.

Preferably, The data storage method further comprises the step of writing the compressed record to a memory.

According to another aspect of the invention, a processing system comprises:

a memory; and

a processor configured to:

receive a first data record and a second data record;

compare the first data record to the second data record; and

compress the second data record in the memory as a difference between the first data record and the second data record.

Preferably, the processor is further configured to truncate a least significant digit of the second data record.

Preferably, the processor is further configured to move a positive or negative indicating digit from a beginning of the first or the second data record to an end of the data record.

Preferably, the processor is further configured to represent the second data record with a header nibble and one or more data nibbles.

Preferably, the header nibble represents the number of data nibbles in the compressed record.

Preferably, the header nibble represents whether the second data record is greater than, less than, or equal to the first data record.

Preferably, the one or more data nibbles comprise the difference between the first data record and the second data record.

Preferably, the processor is further configured to store the second data record uncompressed if the difference between the first data record and the second data record cannot be represented by a predetermined number of nibbles.

Preferably, the processor is further configured to set the first data record as a baseline record and compare subsequently received data records to the baseline record.

### BRIEF DESCRIPTION OF THE DRAWINGS

FIG. 1 shows a processing system according to an embodiment of the invention.

FIG. 2 shows a compression algorithm according to an embodiment of the invention.

FIG. 3 shows a compression algorithm according to another embodiment of the invention.

### DETAILED DESCRIPTION OF THE INVENTION

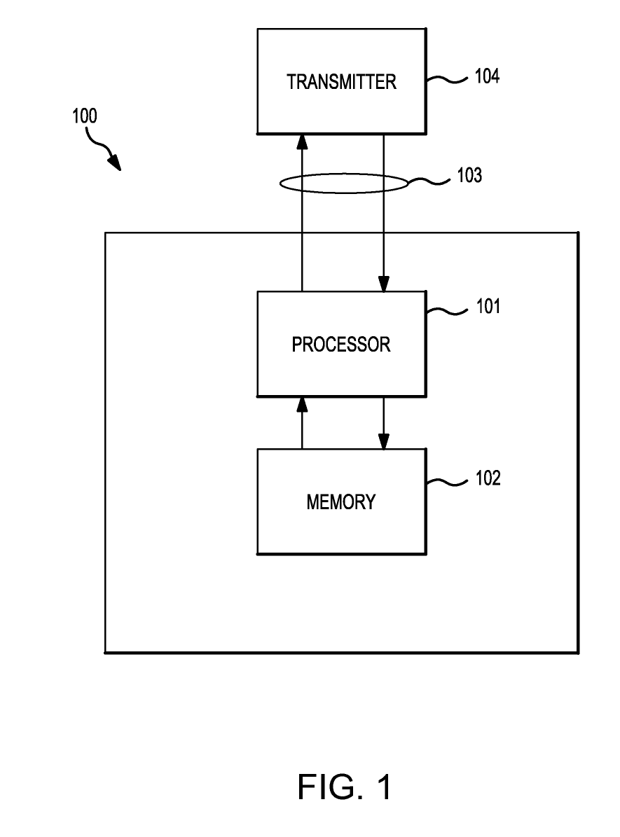

FIGS. 1-3 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 shows a processing system 100 according to an embodiment of the invention. The processing system 100 comprises a processor 101 and a memory 102. The processing system 100 can comprise a general purpose computer, a micro-processing system, a logic circuit, a digital signal processor, or some other general purpose or customized processing device. The processing system 100 can be distributed among multiple processing devices. The processing system 100 can include any manner of integral or independent electronic storage medium, such as the memory 102. Connected to the processing system 100 by a bus loop 103 is a transmitter 104. The transmitter 104 may be connected to any number of devices, including, but not limited to flow measurement devices such as vibrating flow meters, including Coriolis flow meters, for example. The transmitter 104 can be configured to send information to the processing system 100. The information may comprise flow measurements, for example. However, it should be understood that the information sent by the transmitter will depend on the particular device (not shown) connected to the other end of the transmitter. Therefore, the present invention should not be limited to data consisting of fluid flow information.

According to an embodiment of the invention, the data processor 101 can receive incoming bits of data from the transmitter 104 and compress the incoming bits of data prior to sending the data to the memory 102. The processor 101 may compress a current data record based on a difference between the current data record and a previous data record. Unlike the prior art methods, which only compress the portion of the data record that is identical to the previous data record, but not the portion of the record that differs from the previous record, the present invention can compress substantially all of the data record. According to an embodiment of the invention, the compressed data record is written as a difference between the current record and a second record. According to another embodiment of the invention, the compressed data record is written as the difference between the previous record and the current record. According to yet another embodiment of the invention, the compressed data record is written as the difference between the current record and a baseline record.

According to an embodiment of the invention, the data received by the processor 101 comprises a digital bit stream. It should be understood that the data does not have to comprise a digital bit stream. Therefore, the particular form of data received by the processor 101 should not limit the scope of the present invention. However, digital bit streams can easily be divided into distinct uniform groups such as nibbles (4 bits) or bytes (8 bits) as discussed further below.

According to an embodiment of the invention, the processor 101 can represent the incoming bits of data as decimal or hexadecimal characters, for example. It should be understood that the incoming data does not have to be represented as hexadecimal characters; however, in some embodiments, hexadecimal code may provide better compression than a decimal representation.

According to an embodiment of the invention, the processor 101 can write the incoming data as a compressed record in the memory 102. The processor 101 may compress the incoming data into a string of nibbles. The string of nibbles may comprise a series of “header” nibbles. According to an embodiment of the invention, each header nibble can be followed by one or more data nibbles. The number of data nibbles can vary depending on the particular definition assigned to each header nibble. However, in one embodiment, the number of data nibbles can vary from one to eight. According to an embodiment of the invention, the number of data nibbles may depend on the amount that consecutive data records vary from one another. It should be understood that although the present embodiment is described as compressing the data into nibbles, the particular number of bits grouped together can vary and therefore, the invention should not be limited to groupings of four bits. Rather any number of bits may be grouped together.

According to an embodiment of the invention, the following table may be used to represent the header nibbles, which utilizes hexadecimal characters. It should be understood that the table is provided merely as an example and persons skilled in the art will readily recognize various other header definitions that fall within the scope of the present invention.

TABLE 1

| F | 8 nibbles follow | Uncompressed |
|---|---|---|
| E | 7 nibbles follow | Value represents new value − previous value |
| D | 6 nibbles follow | Value represents new value − previous value |
| C | 5 nibbles follow | Value represents new value − previous value |
| B | 4 nibbles follow | Value represents new value − previous value |
| A | 3 nibbles follow | Value represents new value − previous value |
| 9 | 2 nibbles follow | Value represents new value − previous value |
| 8 | 1 nibble follows | Value represents new value − previous value |
| 7 | 7 nibbles follow | Value represents previous value − new value |
| 6 | 6 nibbles follow | Value represents previous value − new value |
| 5 | 5 nibbles follow | Value represents previous value − new value |
| 4 | 4 nibbles follow | Value represents previous value − new value |
| 3 | 3 nibbles follow | Value represents previous value − new value |
| 2 | 2 nibbles follow | Value represents previous value − new value |
| 1 | 1 nibble follows | Value represents previous value − new value |

| | |
|---|---|
| 0x | Where ‘x’ nibble represents 1-15 values are exact same as |
| | previous |
| x0 | Value not allowed |

The first column in Table 1 is the hexadecimal value of the header nibble in the compressed record. It should be appreciated that the hexadecimal value may be provided to the user/operator to represent the binary values actually stored in the memory 102. The second column in Table 1 provides how many data nibbles follow the particular header nibble. The third column in Table 1 describes what the data nibbles represent. For example, if the header nibble is ‘E’, then seven data nibbles follow where the data nibbles represent the new value—the previous value. In other words, the current record is greater than the previous record. If the records comprise flow measurements, this may mean that the current measurement is greater than the previous measurement, for example.

A compression algorithm may be used in conjunction with the above definitions to compress incoming bits of data based on a difference between a current data record and a previous, uncompressed, data record. The compressed record written to the memory 102 may comprise the difference between the uncompressed record and the previous record.

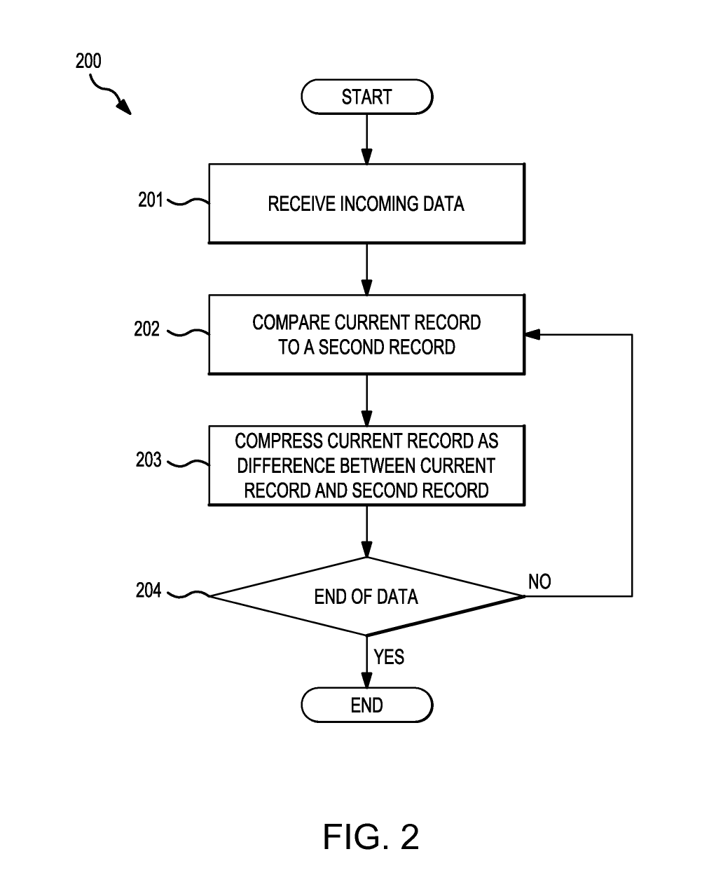

FIG. 2 shows a data compression algorithm 200 according to an embodiment of the invention. The algorithm 200 may be initiated by a user/operator or alternatively, may be initiated by another program operated by the processor 101. According to the embodiment shown in FIG. 2, the processor 101 can receive the incoming data in step 201.

In step 202, the processor 101 can compare the current record to a second data record. In some embodiments, the second record comprises the previous record. If there is no previous record to compare the current record to, the processor 101 can store the record uncompressed. According to an embodiment of the invention, the stored record can comprise a header nibble followed by one to eight data nibbles. The value of the header nibble will depend upon how long the data record is. In other words, the value of the header nibble will depend on the difference between the current record and the previous record. According to an embodiment of the invention, the header nibble can be based on the values in Table 1. According to an embodiment of the invention, the processor 101 can temporarily store the record in order to compare the current record to the subsequently received record. The current record may be stored, uncompressed, in a cache memory, or similar memory until step 203 (below) is completed.

The processor may determine if the difference between the first and second record can be represented by a predetermined number of nibbles. According to one embodiment where the processor 101 implements the definitions of Table 1, the predetermined number of nibbles would be eight because the highest header nibble only provides for eight data nibbles to follow. However, if other header nibble definitions are implemented, the predetermined number of data nibbles can vary.

If the difference can be represented by the predetermined number of nibbles, the processor 101 proceeds to step 203 where the current record is compressed as the difference between the current record and the second record. In some embodiments, the compression represents the difference between the current record and the previous record. According to an embodiment of the invention, the processor 101 can compress the current record into a record comprising a header nibble followed by one or more data nibbles. According to an embodiment of the invention, the header nibble can indicate the number of data nibbles that follow. According to another embodiment of the invention, the header nibble can represent whether the current record is greater than, less than, or equal to the previous record. According to an embodiment of the invention, the data nibbles represent the difference between the currently compressed record and the previous record. If the difference cannot be represented by the predetermined number of nibbles, the processor 101 can store the record uncompressed rather than compressing the record. The uncompressed record may still include a header nibble. For example, if the header nibbles are defined as in Table 1 above, then the header nibble of an uncompressed record comprising eight nibbles would be ‘F’.

In step 204, the processor 101 can determine if the current record comprises the last record. If the record comprises the last record, then the algorithm 200 can end. The processor 101 can also write the current record in as a compressed record in memory 102 without temporarily storing the current record. This is because there is not a subsequent record which the current record must be compared with. If more incoming data records exist, then the algorithm 200 can return to step 202 where the subsequent record can be compared to the current record.

An example of the algorithm 200 implemented on integer data values is shown below to aid in the understanding of the present invention according to an embodiment of the invention. Take for example the following incoming data records where each of the decimals represents a nibble in binary code.

(1) 12345678

(2) 12345678

(3) 12345678

(4) 12345677

(5) 12345675

(6) 12345676

According to the algorithm 200, the processor 101 can receive the first data record and because there is not a previous record to compare the first data record to, the processor 101 can store the first data record along with a header nibble indicating that eight nibbles follow. Therefore, the compressed format would be F12345678, where ‘F’ is the header nibble representing that eight nibbles follow that are uncompressed. In other words, the eight data nibbles comprise the original incoming data.

According to an embodiment of the invention, the processor 101 can then receive the second data record, which is identical to the first data record. Therefore, the processor 101 can proceed to the third data record, which is also identical to the first data record. The processor 101 can then proceed to the fourth data record. Because the fourth data record is not identical to the first data record, the second and third data records can be compressed into two nibbles, one header nibble representing that the record is identical to the previous record and one data nibble representing how many records are identical. In this case, the second and third data records are identical to the first data record and therefore, the data nibble would be 2. Therefore, the second and third data records would be compressed as ‘02’.

The processor 101 can then compare the fourth data record to the third data record. In this case, the difference is one (12345678−12345677). Furthermore, the fourth data record is less than the third data record. Because the difference can be represented by less than the predetermined number of data nibbles (eight in this case), the processor 101 can compress the record. In this case, the fourth data record would be compressed as ‘11’, where the header nibble is a 1, which represents that 1 nibble follows and that the value of the data nibble represents the old value−new value. The data nibble is a 1 because the difference is 1.

A similar comparison is made between the fifth data record and the fourth data record; however, the fifth data record differs from the fourth data record by two. Therefore, the compressed record would be stored as ‘12’.

The sixth data record is greater than the fifth data record. However, the difference can still be represented in one nibble. Therefore, the sixth data record would be compressed as ‘81’, where the ‘8’ comprises the header nibble representing that one data nibble follows and the data nibble represents a new value−old value. The ‘1’ comprises the data nibble where the difference between the sixth and fifth data records is one.

The processor 101 can thus receive the incoming data stream of 123456781234567812345678123456771234567512345676 and write a compressed record to the memory 102 as F1234567802111281. This results in an overall difference in stored nibbles of 23 (40-17) resulting in an overall compression of 58%.

The present invention as described above provides superior compression compared to the prior art because substantially all of the data record is compressed rather than only the identical portion of the data record. This is because the compressed record written to the memory 102 comprises the difference between the current record and the previous record. Thus, the processor 101 can realize much greater compression ratios than the prior art where only a portion of the data record is compressed.

Although the above description has been shown where the incoming data comprises integer values, it should be understood that the present invention is equally applicable to floating values. Although IEEE-754 Single Precision Floating Point numbers are used in the example below, it should be understood that IEEE-7554 Double Precision as well as other standards for floating point data could equally be used. Therefore, the present invention should not be limited to IEEE-754 Single Precision Floating Point numbers. Consider the following incoming data comprising floating numbers, where the floating value is followed by the converted hexadecimal representation. Again, it should be appreciated that each hexadecimal character represents four bits of binary code.

(1) 4.0218 4080B296

(2) 3.7209 406E233A

(3) 3.4170 405AB021

(4) 3.1076 4046E2EB

(5) 2.8633 4037404F

(6) 2.7233 402E4A8C

According to the algorithm 200, the first data record of the above example remains uncompressed and is stored with a header nibble of ‘F’ representing that the record comprises eight nibbles that are uncompressed. Thus, the first data record will actually include an additional nibble (header nibble) resulting in a negative compression. The processor 101 can then receive the second data record and compare it to the first data record. Upon comparison, the processor 101 can determine in step 203 that the difference between the second data record and the first data record can be stored in less than the predetermined number of nibbles (eight). Therefore, the second data record is compressed and stored as the difference between the second data record and the first data record as ‘D128F5C’. In this compressed record, ‘D’ is the header nibble, which according to Table 1 represents that six data nibbles follow and the data nibbles represent the previous value minus the new value. The data nibbles 128F5C represent the difference, in hexadecimal, between the first and second data records.

The processor 101 can compress the remaining data records in a similar manner where the difference between the second and third data records, in hexadecimal, is 137319 and therefore the third data record can be compressed as D137319. Similarly, the difference between the third data record and the fourth data record, in hexadecimal, is 13CD36 and therefore the fourth data record can be compressed as D13CD36. The difference between the fourth data record and the fifth data record is FA29C. Because the difference can be represented in only five nibbles rather than six, the fifth data record can be compressed as CFA29C, where the leading ‘C’ represents that five data nibbles follow and the data nibbles represent the previous value−new value. Similarly, the difference between the fifth data record and the sixth data record is 8F5C3 and therefore the sixth data record can be compressed as C8F5C3.

Compression of the six data records representing floating numbers results in an overall compression of about 12.5%. It can be appreciated that the less consecutive records differ, the less number of nibbles required to represent the difference between the records resulting in a greater compression. According to embodiments where the transmitter 104 transmits fluid flow measurements, the overall compression can depend on the frequency of the measurement. This is because, the more frequent the measurement, the less each measurement will vary from one another. Therefore, although the number of measurements will increase, the difference between measurements may be represented by fewer nibbles resulting in an overall increase in compression.

In addition to the compression discussed above, the processor 101 can implement additional steps in order to increase the compression performed on floating numbers. These additional steps can be referred to as “munging.” According to an embodiment of the invention, the processor 101 can truncate the least significant number in the data record. For certain applications, truncating the least significant number may not affect the accuracy of the data substantially. This is especially true in fluid flow measurements, for example where the incoming measurements are more accurate than required by a customer. According to the current Institute of Electrical and Electronics Engineering Standards Association standards, single-precision floating numbers are represented with eight nibbles, which, when taking into account the mantissa component, represents roughly seven decimal digits of significant figures. According to an embodiment of the invention, the processor 101 represents the data as six digits, thus eliminating the need for one nibble's worth of storage. Thus removing one digit can increase the compression.

In addition, the standards set forth by the Institute of Electrical and Electronics Engineers Standards Association provides that the sign (+/−) of the floating number is represented in the first bit where 0 means the number is positive and 1 means the number is negative. If the incoming data hovers around zero and thus changes signs on a regular basis, the difference would have to be represented with a high number of nibbles even though the absolute difference between the two records may be relatively small. Therefore, according to an embodiment of the invention, the sign is moved from the beginning to the end of the record. Therefore, even if the incoming data changes sign continuously, the represented number processed by the processor 101 would change relatively little and the difference between consecutive records could be represented by fewer nibbles. These additional steps performed by the processor 101 can result in significant increases in compression as the difference between records can be represented by fewer nibbles.

Although the above discussion focuses on data compression, the processor 101 can also decompress the records stored in the memory 102. Decompression can follow similar procedures as the compression algorithm. The records stored in the memory 102 may need to be accessed for a variety of reasons and therefore, the particular record required may vary. If all of the records are required, the processor 101 can simply begin at the beginning of the records and access each record sequentially.

In some situations however, not all of the records need to be accessed at once. If this is the case, the processor 101 can access records required by first identifying which records are required. Once the required records are identified, the processor 101 must find the previously stored record including a header nibble that signifies the data nibbles that follow are uncompressed. For example, if Table 1 were being used, this would correspond to header nibble ‘F’. This uncompressed record is required because all of the subsequently stored records, including the required record, signify a difference between two consecutive records. However, without identifying the previously uncompressed record, the difference may not provide valuable information. Once the uncompressed record is retrieved, the processor 101 can continue to decompress substantially all of the records that follow until the required record is retrieved and decompressed.

It should be appreciated that the sequential access routine discussed above may be adequate in situations where the number of records required to access in order to decompress the record of interest is not prohibitive. However, there may be situations where the number of records decompressed requires an excessive amount of processing time. Therefore, according to an embodiment of the invention, the processor 101 can compress the incoming data according to the compression algorithm 300.

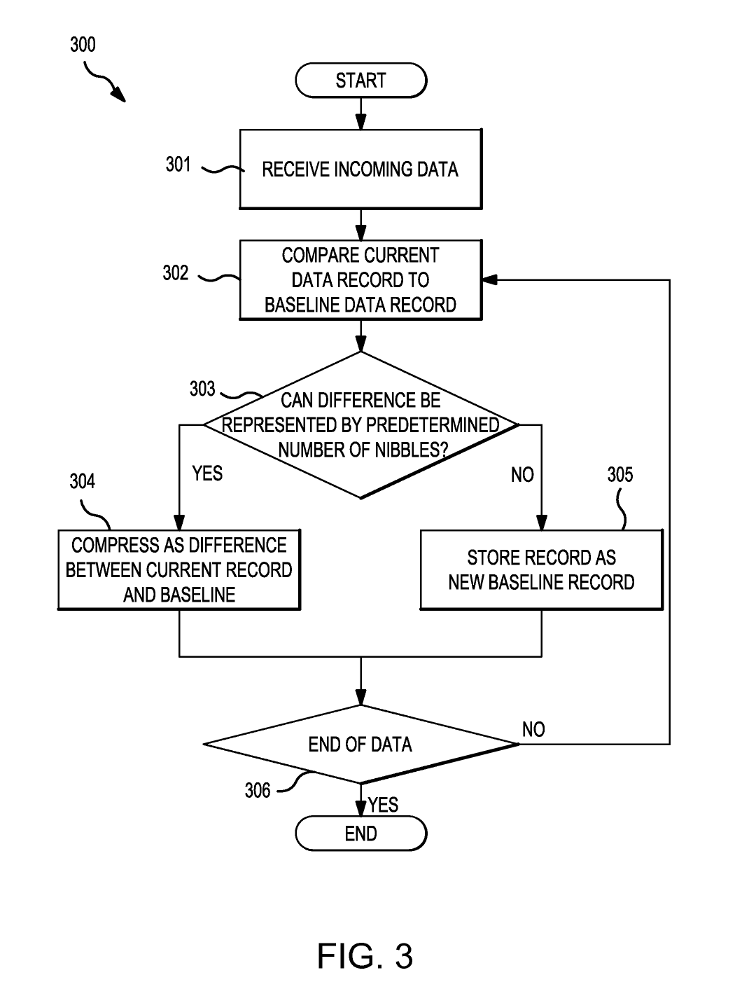

FIG. 3 shows the compression algorithm 300 that can be performed by the processor 101 according to an embodiment of the invention. The compression algorithm 300 is particularly useful in situations where the incoming data does not vary by a significant amount. This may be true in examples where the transmitter 104 is relaying information that is in a steady state or semi-steady state. For example, if the transmitter 104 is coupled to a flow meter where the fluid is flowing at a relatively constant flow rate, the incoming flow rates may not differ significantly. Therefore, there may be a large number of incoming bits of data that can be compressed before an incoming record cannot be compressed according to the algorithm 200. The algorithm 200 can provide high compression ratios as the difference between consecutive records may be able to be represented by a low number of nibbles. However, it may prove troublesome during decompression where a large volume of records must be decompressed in order to access the record of interest. The algorithm 300 overcomes this problem by comparing incoming records of bits of data to a baseline record. According to an embodiment of the invention, the baseline record may comprise the first received record, for example. However, the baseline record may be any received record and is not limited to the first received record. In addition, the baseline record may be a value set by the processor 101. For example, the baseline record may comprise the average value of all of the received records.

The algorithm 300 starts in step 301 where the processor 101 receives incoming data. The incoming data may be in the form of bits of data as discussed above in relation to FIG. 2. According to an embodiment of the invention, the first record may be stored as a first baseline record. The first baseline record can be stored in a similar manner to how the first record is stored in algorithm 200. Take for example the incoming records used in the discussion of the algorithm 200:

(1) 12345678

(2) 12345678

(3) 12345678

(4) 12345677

(5) 12345675

(6) 12345676

The first record could again be stored as F12345678, where ‘F’ indicates that eight nibbles of uncompressed data follow.

In step 302, the processor 101 can compare the current data record to the baseline record. This is in contrast to the algorithm 200, which compares the current record to the immediately preceding record.

In step 303, the processor 101 can determine if the difference between the current record and the baseline record can be represented by the predetermined number of nibbles. If it can, the processor 101 continues on to step 304 where the current record is compressed as the difference between the current record and the baseline record. If on the other hand, the answer is no, the processor 101 can store the current record as a new baseline record in step 305.

In step 306, the processor 101 determines if the previously stored record is the last record, if yes, the algorithm 300 ends. If there are more records to be compressed, the processor returns to step 302.

In the example of the six data records above, the second and third records would be compressed in the same way according to the algorithm 300 as they were compressed according to the algorithm 200, namely, the second and third records would be compressed as ‘02’.

The fourth record, according to the algorithm 200, was written as compressed record ‘11’. The fourth record, according to the algorithm 300, would also be written as ‘11’ because the difference between the first baseline record and the fourth record is still one and can therefore be written using one nibble.

The fifth record, according to the algorithm 200, was written as compressed record ‘12’ based on the difference between the fourth record and the fifth record. However, according to the algorithm 300, the fifth record is compared to the first baseline record. The difference between the fifth record and the baseline record is three (12345678−12345675). Therefore, the fifth record would be written as compressed record ‘13’.

The sixth record, according to the algorithm 200, was written as compressed record ‘81’. However, according to algorithm 300, the sixth record would be written as ‘12’ based on the difference between the first baseline record and the sixth record.

In the example above, the compression ratio is the same for both algorithms. It should be appreciated that this will not always be the case. If the incoming data is continuously changing in a single direction, for example, if the incoming data is rising, then the algorithm 300 may not provide as much compression as the algorithm 200. This is because the compressed records may require more nibbles to represent the difference between the record being compressed and the baseline record than would be required for representing the difference between the record being compressed and the previous record.

The advantage to the algorithm 300 over the algorithm 200 is realized during decompression. Rather than requiring decompression of all of the records between the first uncompressed record and the required record as in the algorithm 200, the algorithm 300 only requires decompression of the baseline record and the required record. Referring again to the six example records provided above, if the fifth record were required to be decompressed, the processor 101 would have to decompress five records (1-5) in order to obtain the decompressed record five according to the algorithm 200. However, according to the algorithm 300, in order to access the fifth record only two records need to be decompressed, the first baseline record and the fifth record. Thus, the processing time required to access certain records may be substantially decreased according to the algorithm 300.

It should be appreciated that according to an embodiment of the invention, the baseline record does not need to be the first received record. Rather, the baseline record may comprise any record. In addition, it should be appreciated that a new baseline record is required each time the difference between the current record and the baseline record cannot be represented by a predetermined number of nibbles. Therefore, within a given number of data records, there may be multiple baseline records. When accessing a record during decompression, the processor 101 only needs to access the closest prior baseline record. Advantageously, the processing time required to decompress a given record may be reduced. The algorithm 300 is especially useful in situations where a user/operator wants to access specific records without the need to access all of the records.

The invention as described above provides a method for compressing sequentially accessed records of bits of data. The invention provides an advantage over the prior art by writing a compressed record to memory representing the difference between the current data record and a second data record. The second data record may comprise the immediately previously received data record or it may comprise a baseline data record previously received, but not necessarily the immediately prior record. In either case, the compressed record comprises a difference between two records rather than storing an uncompressed portion of the record that differs from another record as in the prior art. Advantageously, the present invention can realize much greater compression ratios than could be realized in the prior art where only the identical portions of records are compressed.

The invention also provides for an efficient method for decompressing the data. According to an embodiment of the invention, the processor 101 can identify a previously stored uncompressed record and decompress the records stored between the desired record and the uncompressed record. According to another embodiment, the processor 101 can identify a previously stored uncompressed record, such as a baseline record and obtain the desired record based solely on the baseline record.

The detailed descriptions of the above embodiments are not exhaustive descriptions of all embodiments contemplated by the inventors to be within the scope of the invention. Indeed, persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention.

Thus, although specific embodiments of, and examples for, the invention are described herein for illustrative purposes, various equivalent modifications are possible within the scope of the invention, as those skilled in the relevant art will recognize. The teachings provided herein can be applied to other storage systems, and not just to the embodiments described above and shown in the accompanying figures. Accordingly, the scope of the invention should be determined from the following claims.

We claim:

1. A data storage method, comprising the steps of:
receiving a first data record and at least a second data record;
comparing the first data record to the second data record; and
compressing the second data record as a difference between the first data record and the second data record.

2. The data storage method of claim 1, further comprising the step of truncating a least significant digit of the second data record prior to the step of compressing.

3. The data storage method of claim 1, further comprising the step of moving a positive or negative indicating digit from a beginning of the first or the at least second data record to an end of the data record.

4. The data storage method of claim 1, wherein the step of compressing the second data record comprises the step of:
compressing the second data record with a header nibble and one or more data nibbles.

5. The data storage method of claim 4, wherein the header nibble represents the number of data nibbles that follow.

6. The data storage method of claim 4, wherein the header nibble represents whether the second data record is greater than, less than, or equal to the first data record.

7. The data storage method of claim 4, wherein the one or more data nibbles comprises the difference between the first data record and the second data record.

8. The data storage method of claim 1, further comprising the step of:
storing the second data record uncompressed if the difference between the first data record and the second data record cannot be represented by a predetermined number of nibbles.

9. The data storage method of claim 1, further comprising the steps of:
setting the first data record as a baseline record; and
comparing subsequently received data records to the baseline record.

10. The data storage method of claim 1, further comprising the step of writing the compressed record to a memory.

11. A processing system (100), comprising:
a memory (102); and
a processor (101) configured to:
receive a first data record and a second data record;
compare the first data record to the second data record; and
compress the second data record in the memory (102) as a difference between the first data record and the second data record.

12. The processing system (100) of claim 11, wherein the processor (101) is further configured to truncate a least significant digit of the second data record.

13. The processing system (100) of claim 11, wherein the processor (101) is further configured to move a positive or negative indicating digit from a beginning of the first or the second data record to an end of the data record.

14. The processing system (100) of claim 11, wherein the processor (101) is further configured to represent the second data record with a header nibble and one or more data nibbles.

15. The processing system (100) of claim 14, wherein the header nibble represents the number of data nibbles in the compressed record.

16. The processing system (100) of claim 14, wherein the header nibble represents whether the second data record is greater than, less than, or equal to the first data record.

17. The processing system (100) of claim 14, wherein the one or more data nibbles comprises the difference between the first data record and the second data record.

18. The processing system (100) of claim 11, wherein the processor (101) is further configured to store the second data record uncompressed if the difference between the first data record and the second data record cannot be represented by a predetermined number of nibbles.

19. The processing system (100) of claim 11, wherein the processor (101) is further configured to set the first data record as a baseline record and compare subsequently received data records to the baseline record.
